(19) United States
(12) Patent Application Publication
(10) Pub. No.: US 2025/0131241 A1
(43) Pub. Date: Apr. 24, 2025

(54) TELEMETRY-BASED MACHINE LEARNING OF INTER-NETWORK

(71) Applicant: Cisco Technology, Inc., San Jose, CA (US)

(72) Inventors: HOSSEIN MOOSAVI, Ottawa (CA); MISHA NOSSIK, Ottawa (CA); BEN ASTELL, Ottawa (CA); OMID MEHRABIAN, Ottawa (CA)

(21) Appl. No.: 18/493,728

(22) Filed: Oct. 24, 2023

(51) Int. Cl. H04L 41/16; G06N 3/0442; H04L 41/14

(52) U.S. Cl. CPC G06N 3/0442

(57) ABSTRACT

Methods and devices provide machine learning of mappings between test script endpoints and network configuration and state differences described according to YANG models. Such machine learning is implemented in a network environment by a training workflow and a production workflow, each implemented across a network device and a machine learning computing system, and each utilizing a learning model which includes an encoder-decoder architecture. The learning model is trained on training datasets which include mappings of executable endpoints to YANG model differences, generated by telemetry capture in network environments to generate training datasets.

### TECHNICAL FIELD

This disclosure relates generally to machine learning based on telemetry conducted in a network environment configured to execute test scripts by a testing tool.

### BACKGROUND

Network administrators are interested in testing behavior of computing hosts and network devices of a network in response to various operating parameters and configurations, collecting test results as a basis to change or upgrade network configuration and computing services deployed on the network. Test results provide feedback to improve performance of computing services for end users, and minimize errors and failures, in a production network environment. In accordance with testing practices in network administration, network management data, such as configurations, states, and remote procedure calls, is communicated between network devices of a production network environment and controllers outside the network environment.

Configurations can be deployed and tested in a network environment by executing test scripts including procedure calls according to various command-line interfaces (“CLIs”), or executable according to various application programming interfaces (“APIs”) of network management protocols. Test scripts include various configurations to be deployed and tested in a network environment, and thus numerous procedure calls need to be made according to a common CLI or a common API in order to execute the test scripts. Due to the substantial investment of CLI-specific or API-specific implementation required to develop suites of such test script, it is uncommon for test scripts to be interoperable in network environments deploying different CLIs and APIs.

Consequently, test scripts tend not to be portable between heterogeneously configured network environments, and, in the event that a network environment is configured to depreciate a previously configured CLI or API, backward compatibility cannot be maintained with existing test scripts. It is a challenge to adapt existing test scripts, which can represent extensive investment in developer work hours, to differently configured network environments, or existing network environments that have been newly configured, without substantially re-investing those work hours in rewriting tests according to a new CLI or API.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The devices depicted in the accompanying figures are not to scale and components within the figures may be depicted not to scale with each other.

FIG. 1 illustrates a diagram of network devices of one or more networks, according to example embodiments of the present disclosure.

FIG. 2 illustrates a swim lane diagram of a testing protocol according to example embodiments of the present disclosure.

FIG. 3 illustrates a flow diagram of a training workflow implemented across a network device and a machine learning computing system according to example embodiments of the present disclosure.

FIG. 4 illustrates a flow diagram of a production workflow implemented across a network device and a machine learning computing system according to example embodiments of the present disclosure.

FIGS. 5A and 5B illustrate examples of a learning model according to example embodiments of the present disclosure.

FIG. 6A illustrates an example system architecture of a machine learning computing system configured to compute machine learning tasks according to example embodiments of the present disclosure.

FIG. 6B illustrates an example of special-purpose processors according to example embodiments of the present disclosure.

FIG. 7 shows an example architecture for a network device capable of being configured to implement the functionality described herein.

### DESCRIPTION OF EXAMPLE EMBODIMENTS

### Overview

This disclosure describes telemetry capture in network environments to generate training datasets mapping test script endpoints according to a command-line interface (“CLI”) or an application programming interface (“API”) of a network management protocol to YANG model differences; and training a machine learning model based on a training dataset mapping test script endpoints to YANG model differences.

Example embodiments of the present disclosure provide machine learning of mappings between test script endpoints and network configuration and state differences described according to YANG models. Such machine learning is implemented in a network environment by a training workflow and a production workflow, each implemented across a network device and a machine learning computing system, and each utilizing a learning model which includes an encoder-decoder architecture. The learning model is trained on training datasets which include mappings of executable endpoints to YANG model differences, generated by telemetry capture in network environments to generate training datasets.

The described techniques may be implemented in one or more network devices having one or more processing units configured to execute computer-executable instructions, which may be implemented by, for example, one or more application specific integrated circuits (“ASICs”). The processing units may be configured by one or more non-transitory computer-readable media storing computer-executable instructions that, when executed by the processing units cause the processing units to perform the steps.

Additionally, the techniques described herein may be performed by a device having non-transitory computer-readable media storing computer-executable instructions that, when executed by one or more processors, performs the method described above.

### Example Embodiments

According to example embodiments of the present disclosure, a network is configured by a network administrator over an infrastructure including network hosts and network devices in communication according to one or more network protocols. Outside the network, any number of client devices, external devices, and the like can connect to any host of the network in accordance with a network protocol. One or more networks according to example embodiments of the present disclosure can include wired and wireless local area networks (“LANs”) and such networks supported by IEEE 802 LAN standards. Network protocols according to example embodiments of the present disclosure can include any protocol suitable for delivering data packets through one or more networks, such as, for example, packet-based and/or datagram-based protocols such as Internet Protocol (“IP”), Transmission Control Protocol (“TCP”), User Datagram Protocol (“UDP”), other types of protocols, and/or combinations thereof.

It should be understood that client devices can include computing devices and systems operated by end users, organizational personnel, and other users, which connect to a campus network as described subsequently. Client devices can also include external devices such as rack servers, load balancers, and the like, which connect to a data center as described subsequently.

The network can be configured to host various computing infrastructures; computing resources; software applications; databases; computing platforms for deploying software applications, databases, and the like; application programming interface (“API”) backends; virtual machines; and any other such computing service accessible by users accessing the network from one or more client devices, external devices, and the like. Networks configured to host one or more of the above computing services can be characterized as private cloud services, such as data centers; public cloud services; and the like. Such networks can include physical hosts and/or virtual hosts, and such hosts can be located in a fashion collocated at premises of one or multiple organizations, distributed over disparate geographical locations, or a combination thereof.

A network administrator can control access to the network by configuring a network domain encompassing computing hosts of the network and network devices of the network. A network administrator can further configure a computing host as a domain controller, the domain controller being configured to handle authentication requests from client devices by an authentication protocol, so that users who successfully authenticate over their client devices can establish a network connection to the network domain.

Computing hosts of the network can be servers which provide computing resources for hosted frontends, backends, middleware, databases, applications, interfaces, web services, and the like. These computing resources can include, for example, computer-executable applications, databases, platforms, services, virtual machines, and the like.

Network devices are configured to deliver data packets through one or more networks, such as personal area networks (“PANs”), wired and wireless local area networks (“LANs”), wired and wireless wide area networks (“WANs”), the Internet, and so forth. A network device, such as a router, switch, or firewall, can receive, over one or more network interfaces, packets forwarded over one or more networks from other hosts; determine a next hop, route, and/or destination to forward the packets to; and forward the packets, over one or more network interfaces, to a host determined by the next hop, route, and/or destination. The next hop, route, and/or destination in the one or more networks can be determined by any or any combination of static routing tables and various dynamic routing algorithms.

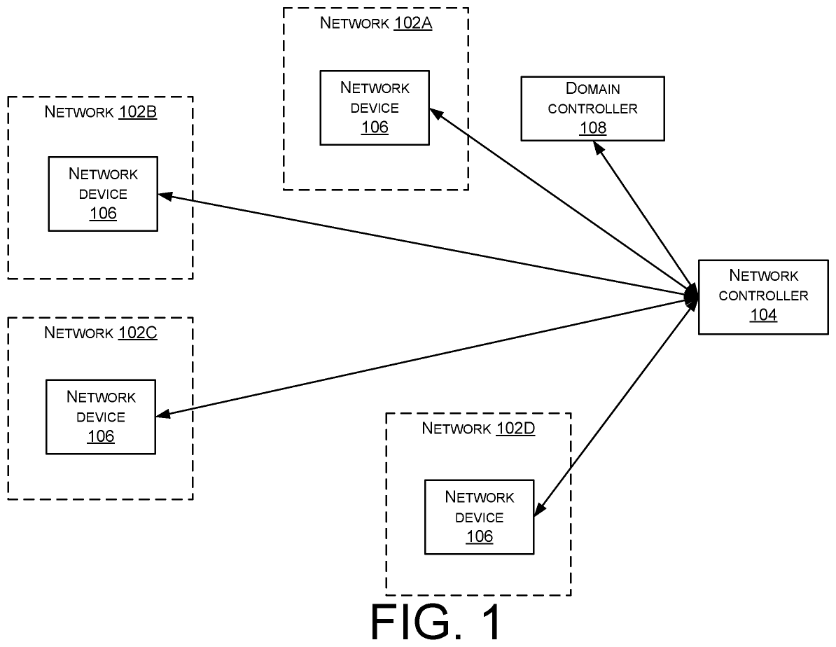

FIG. 1 illustrates a diagram of network devices of one or more networks, according to example embodiments of the present disclosure. FIG. 1 illustrates multiple networks 102A, 102B, 102C, and 102D, which can each be configured in various fashions as described above, as private cloud services, such as data centers, public cloud services, and the like; including physical hosts and/or virtual hosts; and with those hosts being located in a fashion collocated at premises of one or multiple organizations, distributed over disparate geographical locations, or a combination thereof.

FIG. 1 further illustrates a network controller 104 in communication with network devices 106 of each of the multiple networks 102A, 102B, 102C, and 102D. The network controller 104 is remote to each of the multiple networks, and can remotely communicate with network devices of any of the networks according to network protocols as described above.

Though example embodiments of the present disclosure can be implemented with a network controller 104 in communication with network devices of only one network, or with network devices of multiple networks concurrently, it should be understood that FIG. 1 illustrates multiple networks by way of example to illustrate that networks according to example embodiments (and network devices therein) can be heterogeneously configured for different computing services and/or different communication protocols, and the network controller 104 can interoperate with all such heterogeneous configurations of networks and network devices.

For example, the heterogeneous configurations of networks can include data centers and campuses. A data center can be configured to perform high-bandwidth data exchange between external devices, such as rack servers, load balancers, and the like, and can therefore be configured over primarily wired LAN connections. A campus can be configured to serve hosted computing services, applications, databases, and the like to client devices, over a range of possible bandwidths.

Furthermore, in each of the multiple networks 102A, 102B, 102C, and 102D, network devices can include any variety of electronic network devices having specifications generally as described subsequently, such as routers, switches, firewalls, and the like. Underlying hardware configurations of network devices can include commodity hardware, custom hardware, and any other combination thereof. It should be understood that, according to example embodiments of the present disclosure, network devices can be subsequently described using terminology applicable to devices running operating systems based on the Linux kernel, though embodiments of the present disclosure can be implemented on network devices running any suitable network operating system (“NOS”).

Furthermore, it should be understood that, according to example embodiments of the present disclosure, a NOS running on network devices configures the network devices to communicate with other devices and systems over a network according to a network management protocol. A network administrator can operate devices or systems, such as a network controller 104, which are external to a network, to remotely configure network devices of the network and remotely command network devices of the network.

For example, a network management protocol can be the Network Configuration Protocol (“NETCONF”), as published by the Internet Engineering Task Force (“IETF”) in RFC 4741 and RFC 6241, or can be the Simple Network Management Protocol (“SNMP”), as published by the IETF in RFCs 3411 to 3418. A network management protocol configures network devices of the network to deploy configurations in a standard format. For example, configurations according to a network management protocol can be formatted in Extensible Markup Language (“XML”), JavaScript Object Notation (“JSON”), or any other suitable data object format operative to format configuration files.

Moreover, a NOS running on network devices further configures the network devices to perform remote procedure calls (“RPCs”) which can be forwarded according to the network management protocol. By an RPC protocol, a network administrator can operate devices or systems outside a network, such as a network controller 104, to remotely configure network devices to run computer-executable instructions without physically accessing the network devices. Furthermore, by some RPC protocols, a network administrator can operate devices or systems outside a network, such as a network controller 104, to remotely cause network devices to collect telemetry data and to publish telemetry data on one or more networks, by output interfaces such as streaming interface. Google Remote Procedure Call (“gRPC”) is an example of an RPC protocol by which an NOS can configure network devices to be remotely configured; to execute remote commands; and to collect and publish telemetry data in response to remote commands.

FIG. 1 further illustrates a domain controller 108, which can be one of the computing hosts of a network, which can furthermore be configured as part of a network domain encompassing computing hosts of the network. A network administrator can configure a domain controller 108 to handle authentication requests from client devices by an authentication protocol, so that users who successfully authenticate over their client devices can connect to the network domain. Thus, FIG. 1 illustrates an authenticated network connection from the network controller 104 to the domain controller 108, and then from the domain controller 108 to a network device 106 of a network 102A.

Furthermore, by some RPC protocols, a network administrator can operate a network controller 104 to transmit an authentication request to any network device, so that, upon obtaining authentication, the network controller 104 can establish a network connection to any network device directly without connecting to a domain controller. FIG. 1 further illustrates several authenticated network connections from the network controller 104 to respective network devices 106 (without interconnecting through a domain controller) of networks 102B, 102C, and 102D.

According to example embodiments of the present disclosure, network administrators can operate a network controller 104 to, in accordance with a network management protocol and/or an RPC protocol, establish one or more network connections to one or more network devices, and forward operation, administration, and maintenance (“OAM”) packets over the one or more network connections to the one or more network devices.

Network administrators generally understand that OAM refers to a collection of protocols practiced in administrating and maintaining networks such as those described herein. Network administrators can configure network devices of a network to run OAM services (not illustrated herein) across a transport layer of the network; for the purpose of understanding example embodiments of the present disclosure, it should be appreciated that a running OAM service can configure a network device to parse OAM packets, a data packet format carrying telemetry data describing network performance, allowing network administrators to monitor and trace network traffic, thus discerning abnormal packet forwarding, packet loss, and the like. In accordance with in-situ OAM (“iOAM”) proposals, OAM services can configure network devices to encapsulate packets according to various packet header protocols, such as IPV6, SRv6, VXLAN, and the like. It should be appreciated that network devices and network controllers can be configured to arbitrarily encapsulate and decapsulate packets with headers having OAM telemetry data embedded therein, according to OAM techniques.

Moreover, OAM protocols are developed to monitor and trace network traffic across one or more networks end-to-end; for example, with reference to the one or networks illustrated in FIG. 1, end-to-end packet traffic can travel from client devices through ingress interfaces into campus networks, through data center networks, and then through egress interfaces to other client devices. For these reasons, OAM services configure network devices to transmit packets across at least multiple networks, such as between a campus network, a private data center network, and a public cloud network, as well as outside the network through ingress and egress interfaces. Consequently, network administrators seeking to operate example embodiments of the present disclosure can rely upon OAM services already running on network devices 106 to propagate remotely transmitted configurations and commands through one or more networks, end-to-end.

According to example embodiments of the present disclosure, network devices can include routers, switches, firewalls, and the like. A network device can receive packets forwarded over one or more network links from a host internal to or external to the one or more networks; determine a next hop, route, and/or destination to forward the packets to; and forward the packets to a host internal to or external to the one or more networks, determined by the next hop, route, and/or destination. A network device can be configured to determine a next hop, route, and/or destination by any combination of static routing tables and various dynamic routing algorithms.

A network device can be a physical electronic device having one or more processing units configured to execute computer-executable instructions, which can be implemented by, for example, one or more application specific integrated circuits (“ASICs”). The processing units can be configured by one or more non-transitory computer-readable media storing computer-executable instructions that, when executed by the processing units cause the processing units to perform the steps. For example, the computer-executable instructions can be encoded in integrated circuits of one or more ASICs, stored on memory of one or more ASICs, and the like. Furthermore, processing units can be implemented by one or more central processing units (“CPUs”), each including one or more cores.

A network device 106 can include computer-readable media, including volatile storage such as memory, and non-volatile memory such as disk storage, that stores an operating system. The operating system can generally support processing functions of the processing unit, such as computing packet routing according to one or more routing algorithms, modifying forwarding tables, distributing packets to network interfaces, and so forth.

A network device can be configured to run computer-executable instructions stored in one or more software images flashed onto computer-readable media of the network device, such as a Basic Input/Output System (“BIOS”), an NOS, and firmware. Software images as described herein can be characterized logically as one or more modules which configure one or more processing units of the network device to perform one or more related operations.

A network device 106 can include one or more network interfaces configured to provide communications between a respective processing unit and other network devices. The network interfaces can include devices configured to communicate with systems on PANs, wired and wireless LANs, wired and wireless WANs, and so forth. For example, the network interfaces can include devices compatible with Ethernet, Wi-Fi™, and so forth.

According to example embodiments of the present disclosure, a network device, include a router, a switch, a firewall, and the like, can be a computing system having one or more types of hardware modules installed permanently or exchangeably. These hardware modules can include additional processing units, such as ASICs, having computer-executable instructions embedded thereon, as well as computer-readable media having computer-executable instructions stored thereon. They can further include additional network interfaces.

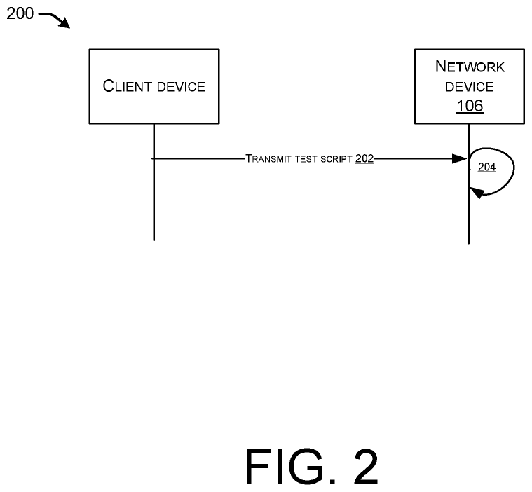

FIG. 2 illustrates a swim lane diagram of a testing protocol 200 according to example embodiments of the present disclosure. Steps of the testing protocol 200 can be performed between a client device and a network device 106 of any network as illustrated above with reference to FIG. 1.

At a step 202, a client device transmits a test script over a network connection to a network device.

Similar to the above description, a client device can be configured to establish a network connection according to a network management protocol and/or an RPC protocol. The client device can be configured to establish a network connection according to a packet-based and/or datagram-based protocol such as Internet Protocol (“IP”), Transmission Control Protocol (“TCP”), User Datagram Protocol (“UDP”), other types of protocols, and/or combinations thereof.

Additionally, the client device can be configured to establish a network connection which forwards test scripts input at a client device (according to a command-line interface (“CLI”) protocol, APIs of a network management protocol, and other such languages operable with network management protocols) to a network device. The network device can be configured by a test library to execute these remotely forwarded test scripts according to a network management protocol and/or an RPC protocol. A client device can be configured to encrypt the CLI commands and transmit the CLI commands over a secure channel by a cryptographic communication protocol such as Secure Shell (“SSH”).

A test library according to example embodiments of the present disclosure runs on a network device or runs on a test subsystem of a network device, configuring the network device or a subsystem thereof to parse a test script and endpoints included therein, and to execute the test script and endpoints included therein in a runtime environment of the network device. A test library configures test scripts and test script endpoints to be run to determine a test pass or a test failure, conditioned upon whether the test script is run to successfully return certain values, parameters, configurations, states, and the like.

Unlike the execution of endpoints included in control plane packets, configuration and state changes deployed or configured in a network environment by executing test script endpoints may be reverted after a test script is run to determine a test pass or a test failure. Alternatively, test script endpoints can be deployed or configured in a network environment other than the runtime environment of a network device, such as a copy of the runtime environment, or a runtime environment of a subsystem of the network device.

Additionally, to establish the network connection to the network device, the client device can be configured to transmit an authentication request to a domain controller as described above with reference to FIG. 1, so that the domain controller can authenticate the client device and allow the client device to establish the connection. Alternatively, to establish the network connection to the network device, the client device can be configured to transmit an authentication request to any network device 106 of one or more networks in accordance with an RPC protocol, so that the network device 106 can authenticate the network controller 104 without the need to communicate with a domain controller. By virtue of the connection being authenticated, the client device is authorized to transmit remote commands to the network device 106, and furthermore can be authorized to establish a secure network connection (such as a network connection encrypted end-to-end according to SSH) on the basis that commands transmitted from an authenticated network controller should not be malicious commands.

It should be understood that not all network devices are configured to establish a network connection by which a remote device, such as the client device, can transmit a remote command to the network device. However, with respect to those network devices which are configured to establish such a network connection, the present disclosure will subsequently refer to the network connection as a “remote session” for the duration that it remains open, for brevity.

At a step 204, the network device parses and executes a test script endpoint.

According to example embodiments of the present disclosure, an “endpoint” refers to a function call or a procedure call executable according to a CLI or according to an API of a network management protocol. For example, a CLI endpoint refers to a function call or a procedure call according to an RPC CLI. A SNMP endpoint refers to a function call or a procedure call according to SNMP. A NETCONF endpoint refers to a function call or a procedure call according to an API of NETCONF.

The client device can forward, and the network device 106 can be configured to parse, any of multiple test script endpoints executable according to a CLI, or according to an API of a network management protocol, to configure operating parameters of a network device 106. By way of example, such executable test script endpoints can include at least the following, without limitation thereto.

Test script endpoints can include a network interface configuration, which can configure the network device 106 to open or close one or more network interfaces of the network device. The network administrator can include such endpoints in one or more test scripts configured to pass or fail based on data packet traffic across one or more network interfaces.

Test script endpoints can include an access control configuration. By way of further elaboration, according to example embodiments of the present disclosure, “access controls” can refer to any implementation of LAN standards which allow access to some client devices outside an access-controlled network domain, and block access to other client devices outside the access-controlled network domain to a physical transmission medium of one or more networks of the access-controlled network domain. Allowance and blocking of access can reflect various authorization policies which describe client devices which are authorized to access the access-controlled network domain and client devices which are not authorized to access the access-controlled network domain.

Among network devices of one or more networks of the access-controlled network domain, some network devices can be configured as network access devices, such as a domain controller as described above. One or more authorization policies can configure network access devices to enforce various types of access control lists (“ACLs”), by identifying client devices as authorized to access the access-controlled network domain or not authorized to access the access-controlled network domain, according to whether client device IP addresses are present on an ACL or not.

The network administrator can include such endpoints in one or more test scripts configured to pass or fail based on data packet traffic across one or more networks to determine consequences of one or more client devices being excluded from accessing a network domain.

Test script endpoints can further include a process termination, which can configure the network device 106 to terminate one or more processes that a processing unit of the network device 106 is running. The network administrator can include such endpoints in one or more test scripts configured to pass or fail based on data packet traffic across one or more networks to determine consequences of one or more running processes being terminated.

Test script endpoints can further include a routing table configuration, which can configure the network device 106 to make one or more modifications to a routing table stored at the network device 106. For example, the network device 106 can delete an entry of a routing table that indicates a next hop to a network destination, therefore excluding a path from the routing table. Furthermore, the network device 106 can insert a new entry of a routing table that indicates an arbitrary next hop to a network destination (where the network destination may or may not have another entry in the same routing table), therefore creating a new path in the routing table. Furthermore, the network device 106 can increase a cost metric recorded in an entry of a routing table, therefore causing a path to be less likely to be selected over other paths.

The network administrator can include such endpoints in one or more test scripts configured to pass or fail based on data packet traffic across one or more networks to determine consequences of routing decisions being influenced by modifications.

Test script endpoints can further include a control plane configuration, which can configure the network device 106 to terminate one or more control plane processes that a processing unit of the network device 106 is running. Such control plane processes are described in further detail subsequently.

Architecture of one or more networks of FIG. 1 can be divided, logically, into at least a control plane and a data plane. The control plane includes collective functions of a network which determine decision-making logic of data routing in the network. For example, the control plane includes hardware functions of a network which record, modify, and propagate routing table information. These hardware functions can be distributed among any number of network devices of a network, including routers, switches, firewalls, and any other devices having decision-making logic.

The data plane includes collective functions of a network which perform data routing as determined by the above-mentioned decision-making logic. For example, the data plane includes hardware functions of a network which forward data packets. These hardware functions can be distributed among any number of network devices of a network, including routers, switches, and other devices having inbound and outbound network interfaces, and hardware running computer-executable instructions encoding packet forwarding logic.

Network devices of the data plane generally forward data packets according to next-hop forwarding. In next-hop forwarding, an ASIC of a network device, configured by computer-executable instructions, can evaluate, based on routing table information (which can be generated by control plane operations), a next-hop forwarding destination of a data packet received on an inbound network interface of a network device; and can forward the data packet over a network segment to the determined destination over an outbound network interface of the network device. It should be understood that individual network devices do not reside wholly within the control plane or data plane, though their routing decision-making operations can define the control plane and their packet forwarding actions can define the data plane.

Network administrators configure different processing units to perform control plane tasks and data plane tasks. For example, according to the CISCO IOS network operating system implemented by CISCO SYSTEMS INC., routing decision-making tasks performed in a control plane are configured to be performed by one or more general-purpose processors of network devices (furthermore including a kernel-level daemon process governing the control plane processes, referred to as IOSd according to CISCO IOS), such as CPUs, and forwarding tasks performed in a data plane are configured to be performed by special-purpose processors, such as ASICs. In this fashion, special-purpose processors are configured to run computer-executable instructions representing dedicated tasks which can be limited in terms of size or length, and general-purpose processors are configured to run a variety of computer-executable instructions representing processes of varying size and higher in computational intensity.

Therefore, the network device 106 terminating one or more control plane processes can disable some or all decision-making logic in maintaining routing tables, causing routing information to become stale in due course. The network administrator can include such endpoints in one or more test scripts configured to pass or fail based on data packet traffic across one or more networks to determine consequences of routing information falling out of date.

Test script endpoints can further include a computing resource configuration, which can configure the network device 106 to allocate computing resources of a dedicated runtime environment, such as processor cycle allocation or memory allocation. The network device 106 thus causes one or more processes in this dedicated runtime environment to experience computing resource constraints. The network administrator can include such endpoints in one or more test scripts configured to pass or fail based on data packet traffic across one or more networks to determine consequences of one or more processes being resource-starved. It should be understood that a dedicated runtime environment can be a computing environment configured at a network device, to which the network device can further allocate a limited subset of its native computing resources, such as limiting the dedicated runtime environment to one processor among multiple, and limiting the dedicated runtime environment to a subset of total available memory.

Test script endpoints can further include an address resolution configuration, which can configure the network device 106 to add, modify, or delete one or more entries of an Address Resolution Protocol (“ARP”) table. ARP processes implemented at a network device 106 configures the network device 106 to map IP addresses to Media Access Control (“MAC”) addresses, and subsequently look up such mappings to resolve IP addresses to MAC addresses while resolving packet destinations. Deleting one or more entries of an ARP table can cause inefficient resolution, or failed resolution, of packet destinations. The network administrator can include such endpoints in one or more test scripts configured to pass or fail based on data packet traffic across one or more networks to determine consequences of one or more ARP table entries being added, modified, or deleted.

Test scripts endpoints of a common test suite are generally executable according to a common CLI, or executable according to a common API of a network management protocol. Consequently, test scripts are often not portable across different network environments, as they may be configured by different CLIs and APIs of different network management protocols. Procedure calls and parameters required to achieve configuration outcomes, such as those described above, may substantially vary in syntax between different CLIs and APIs. In the event that a network environment is transitioned to a different network management protocol, backward compatibility with existing test scripts can also be broken.

It is non-trivial to inter-translate test script endpoints according to different CLIs, or different APIs of various network management protocol, due to the degree of knowledge and proficiency required in each. However, it is desired for test script to be portable across network environments without re-investing substantial effort in re-implementing test script endpoints to achieve the same configuration results in different network environments.

Therefore, example embodiments of the present disclosure provide machine learning of mappings between test script endpoints and network configuration and state differences described according to YANG models. Such machine learning is implemented in a network environment by a training workflow and a production workflow, each utilizing a learning model which includes an encoder-decoder architecture. The learning model is trained on training datasets which include mappings of executable endpoints to YANG model differences, generated by telemetry capture in network environments to generate training datasets.

YANG is a protocol-independent data modeling language, which syntactically defines data structures which describe configuration and state of a network environment according to a standard format. By way of example, for each test script endpoint as described above, configuration and state of a network environment are different before executing the endpoint (subsequently referred to as a “pre-execution configuration” and a “pre-execution state”) compared to after executing the endpoint (subsequently referred to as a “post-execution configuration” and a “post-execution state”). The pre-execution configuration and the pre-execution state, and the post-execution configuration and the post-execution state of a network environment can, respectively, be described by a pre-execution YANG model and a post-execution YANG model, each YANG model including some number of data structures describing respective configuration and state of the network environment. Differences in configuration and differences in state caused by executing the test script endpoint are described by differences between the pre-execution YANG model and the post-execution YANG model (subsequently referred to as a “YANG model difference”).

Therefore, regardless of particular CLIs or APIs of network management protocols which configure a particular network environment, configuration and state changes caused by any test script endpoint executed in a network environment can be captured in a standardized format as a YANG model difference comparing a pre-execution YANG model and a post-execution YANG model. A training dataset can thus be compiled by mapping executed test script endpoints to respective YANG model differences captured from a network environment before and after each respective endpoint was executed. A learning model according to example embodiments of the present disclosure, as described subsequently, can configure a computing system to learn, from such a training dataset, configuration and state changes resulting from various test script endpoints in a network environment as described by a protocol-independent YANG model, so that the computing system can correspond test script endpoints that achieve the same configuration and state changes according to different CLIs or APIs of network management protocols.

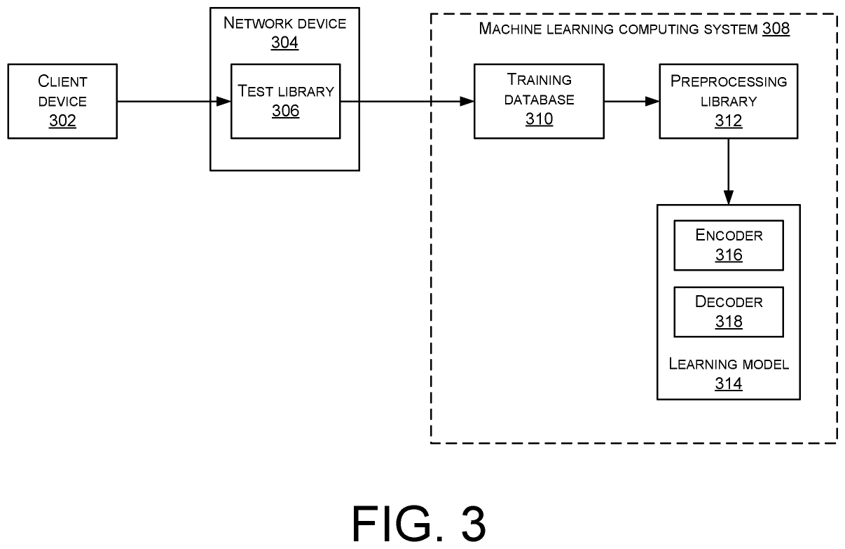

FIG. 3 illustrates a flow diagram of a training workflow implemented across a network device and a machine learning computing system according to example embodiments of the present disclosure.

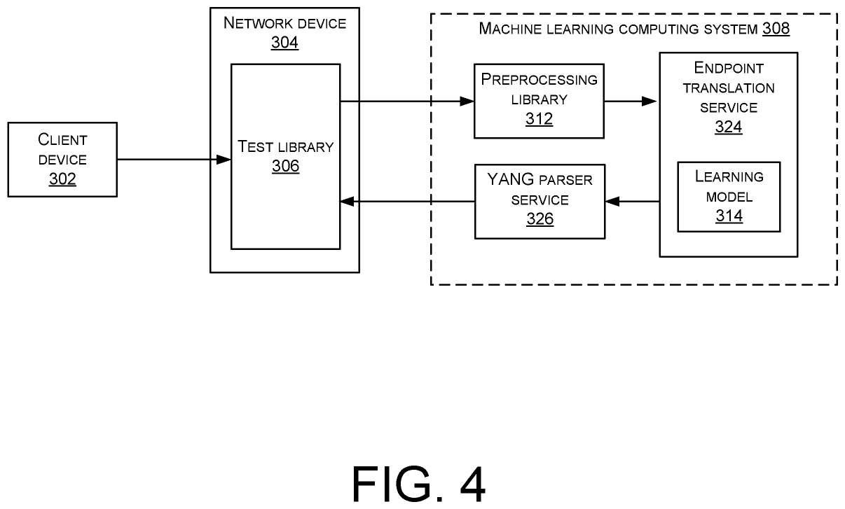

FIG. 4 illustrates a flow diagram of a production workflow implemented across a network device and a machine learning computing system according to example embodiments of the present disclosure.

As illustrated in FIGS. 3 and 4, a client device 302 transmits a test script including one or more executable endpoints over a remote connection to a network device 304. A network device 304 is part of a network as illustrated above with reference to FIG. 1. The network device 304 is configured by a test library 306 in memory of the network device 304, or in memory of a subsystem of the network device 304, to execute a test script and one or more executable endpoints of a test script.

By way of example without limitation thereto, a test script can be a Python script which a Python library configures a network device to execute. A test script can include one or more executable setup endpoints executable by a network device to set up a configuration to be deployed while the test script is running (and can further include one or more executable cleanup endpoints executable by a network device to revert the deployed configuration before the test script finishes running). A test script can further include one or more executable unit tests, where each executable unit test defines inputs into an NOS running on the network device; possible outputs from the NOS; and conditions (i.e., corresponding sets of inputs and/or outputs) which define passing or failure of the unit test.

A test library 306 includes a parser which configures a network device 304 to parse a configuration output of a network management protocol. The configuration output can include reports of parameters of the network device 304 as configured according to the network management protocol. By way of example, a test library 306 can configure a network device 304 to parse an output of a “get-config” procedure call of NETCONF. By a get-config procedure call, a network device 304 is configured by NETCONF to output configuration parameters of the network device 304.

A test library 306 further configures a network device 304 to parse a state output of a network management protocol. The state output can include reports of operational status of the network device 304. By way of example, a test library 306 can configure a network device 304 to parse an output of a “get” procedure call of NETCONF. By a get procedure call, a network device 304 is configured by NETCONF to output operational status of the network device 304, unlike a get-config procedure call as described above.

A test library 306 can configure a network device 304 to capture a YANG model of either or both of a configuration of the network device 304 and state of the network device 304. The parser configures the network device 304 to translate a configuration output described above to a standardized format which describes configuration of the network device 304 according to a YANG model. The parser furthermore configures the network device 304 to translate the state output to a standardized format which describes operational status of the network device 304 according to a YANG model.

Before a test script is executed, a test library 306 can configure a network device 304 to capture a pre-execution YANG model corresponding to the test script based on a pre-execution configuration and a pre-execution state. After a test script is executed, a test library 306 can configure a network device 304 to capture a post-execution YANG model corresponding to the test script based on a post-execution configuration and a post-execution state.

Both a pre-execution YANG model corresponding to the test script and a post-execution YANG model corresponding to the test script are each structured as nodes related by a tree hierarchy contained by a header, each node including one or more data records. A YANG data model can describe, by nodes included therein, parameters of a network device which can be configured by a test script endpoint as described above. By way of example, nodes can describe network interfaces of the network device, ACLs entries of the network device, various types of computing resources of the network device, ARP table entries of the network device, and the like, without limitation thereto. A YANG data model can further describe, by nodes included therein, operational status of a network device which results from configuration of the network device. By way of example, nodes can describe running processes of the network device, running control plane processes of the network device, statuses of network interfaces of the network device, statistics collected from the network device, and the like, without limitation thereto.

After both a pre-execution YANG model corresponding to the test script and a post-execution YANG model corresponding to the test script are captured, a test library 306 can configure a network device 304 to compute a YANG model difference corresponding to the test script by comparing the pre-execution YANG model corresponding to the test script and the post-execution YANG model corresponding to the test script. A YANG model difference can include each node from a pre-execution YANG model corresponding to the test script and each node from a post-execution YANG model corresponding to the test script. For nodes which are present in both the pre-execution YANG model and the post-execution YANG model (i.e., nodes which have the same name and the same hierarchical relationships in both), a YANG model difference records the pre-execution node and the post-execution node. For nodes which are absent from the pre-execution model and for nodes which are absent from the post-execution YANG model, a YANG model difference records an empty node to represent pre-execution absence of the node or post-execution absence of the node.

A test library 306 further configures a network device 304 to map test script endpoints of an executed test script to a YANG model difference corresponding to the test script. The execution of the test script endpoints can be understood to have caused differences in configuration and/or differences in state between pre-execution and post-execution. Therefore, for any number of executed test scripts, their respective endpoints can be mapped to a respective YANG model difference corresponding to the test script, causing each test script endpoint to be mapped to a protocol-independent description of effects upon a network device configuration and a network state caused by execution of that respective endpoint.

An executed test script can include multiple test script endpoints, so that each of these multiple test script endpoints correspond to a same test script, but only one YANG model difference corresponds to the test script. Consequently, mappings from test script endpoints to YANG model differences can be one-to-one or can be many-to-one, while mappings from YANG model differences to test script endpoints can be one-to-one or can be one-to-many.

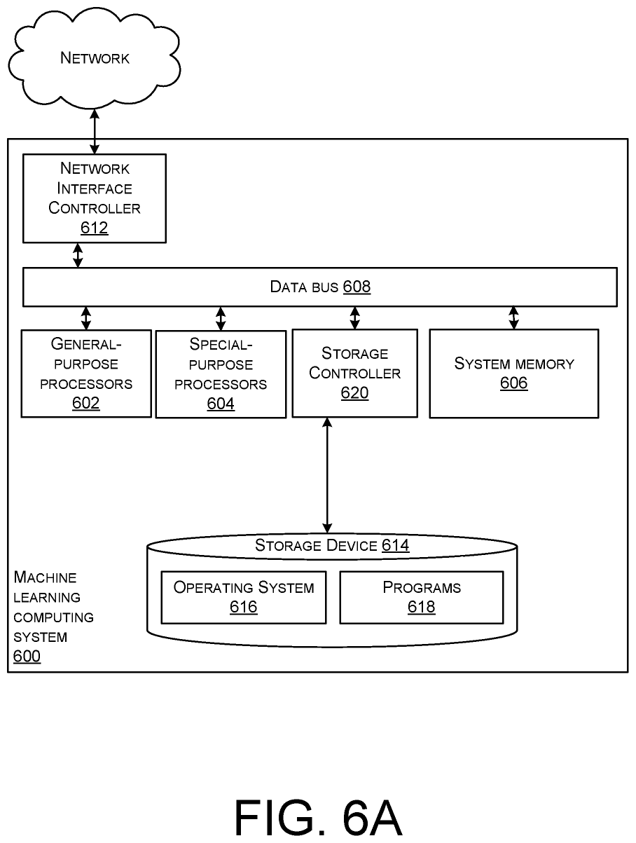

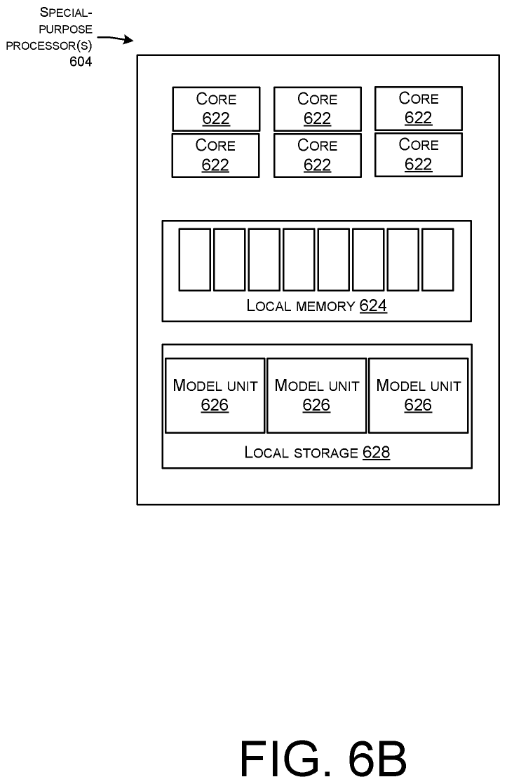

A test library 306 further configures a network device 304 to record, on storage of a machine learning computing system 308, a test script endpoint, a YANG model difference, and a mapping between the test script endpoint and the YANG model difference in a training dataset. The network device 304 can transmit test script endpoints, YANG model differences, and mappings therebetween over any data communication interface of the network device 304 (such as an input/output interface or a network interface) across a data bus, a wired or wireless network connection, and the like, to any data communication interface of the machine learning computing system 308 (as described subsequently with reference to FIGS. 6A and 6B). A training database 310 is recorded on storage of the machine learning computing system 308, the training database 310 being made up of records each composed of a mapping between a test script endpoint and a YANG model difference corresponding to a test script. Subsequently, a “labeled record” of a training database 310 should be understood as such a mapping between an endpoint and a YANG model difference.

A machine learning computing system 308 is configured by a preprocessing library 312 in memory of the machine learning computing system 308 to receive test script endpoints as input, and output feature vectors which encode features of those test script endpoints. The preprocessing library also configures a computing system to receive YANG model differences as input, and output feature vectors which encode features of those YANG model differences. To accomplish this, the machine learning computing system 308 is configured to perform preprocessing tasks upon records of a training database 310. Preprocessing tasks can include, without limitation thereto, tokenization, semantic labeling, and vectorization.

To perform tokenization, a machine learning computing system 308 can, by way of example without limitation thereto, read sequences of bytes from a test script endpoint or from a YANG model difference, and store each character, up to a delimiter character which signifies a break in the sequence of bytes (such as a space, a closing bracket, and the like), as a token stored apart from each other token in an index data structure.

To perform semantic labeling, a machine learning computing system 308 can, by way of example without limitation thereto, read a series of matching rules into memory, where each matching rule corresponds a label to a literal character sequence, a regular expression, and the like. For each matching rule, the machine learning computing system 308 can apply a label to any number of tokens which match the literal character sequence, matching the regular expression, and the like. A label describes semantic meaning of a token.

Alternatively, to perform semantic labeling, a machine learning computing system 308 can input each token into a trained classifier, such as, by way of example without limitation thereto, semi-supervised conditional random field classifier. The trained classifier has been trained on a subset of tokens to which semantic labels have been manually applied. For each token, the conditional random field classifier configures the machine learning computing system 308 to apply a label to the token.

According to example embodiments of the present disclosure, labels applicable to tokens can describe a token as a name of a communication protocol; as a changeable numerical value; as a changeable string value; and the like. Herein, a “changeable numerical value” refers to a numerical value tokenized from a YANG model difference which can express a change from pre-execution to post-execution, and a “changeable string value” refers to a string value tokenized from a YANG model difference which can express a change from pre-execution to post-execution. In short, “changeable numerical values” and “changeable string values” reflect captured changes in configuration of a network device or captured changes in state of a network device caused by an executed endpoint. Therefore, these values can describe effects of deploying endpoints of a test script in a network environment.

It should be understood that any one changeable numerical value can be tokenized into one or more tokens, where each can be semantically labeled as a changeable numerical value, and any one changeable string value can be tokenized into one or more tokens, where each can be semantically labeled as a changeable string value.

To perform vectorization, a machine learning computing system 308 can, by way of example without limitation thereto, translate each test script endpoint token and any labels applied thereto, and each YANG model difference token and any labels applied thereto, to, respectively, an endpoint feature vector and a difference feature vector in a semantic vector space. Each endpoint feature vector and each difference feature vector includes real-valued syntactical features representing syntax of endpoint tokens or syntax of difference tokens, and each endpoint feature vector and each difference feature vector includes real-valued semantic features representing labels applied to endpoint tokens or labels applied to difference tokens.

Furthermore, the machine learning computing system 308 assigns a unique identifier to each token. Additionally, the machine learning computing system 308 separates test script endpoint tokens from YANG model difference tokens, inserts all test script endpoint tokens into a first array, and inserts all YANG model difference tokens into a second array. Each tokenized test script endpoint can be read from the first array as a feature vector indexed by a concatenation of unique identifiers of tokens making up a test script endpoint. Each tokenized YANG model difference can be read from the second array as a feature vector indexed by a concatenation of unique identifiers of tokens making up a YANG model difference.

Consequently, each tokenized test script endpoint can be read from the first array as a feature vector, or as the original endpoint. Each YANG model difference can be read from the second array as a feature vector, or as the original YANG model difference.

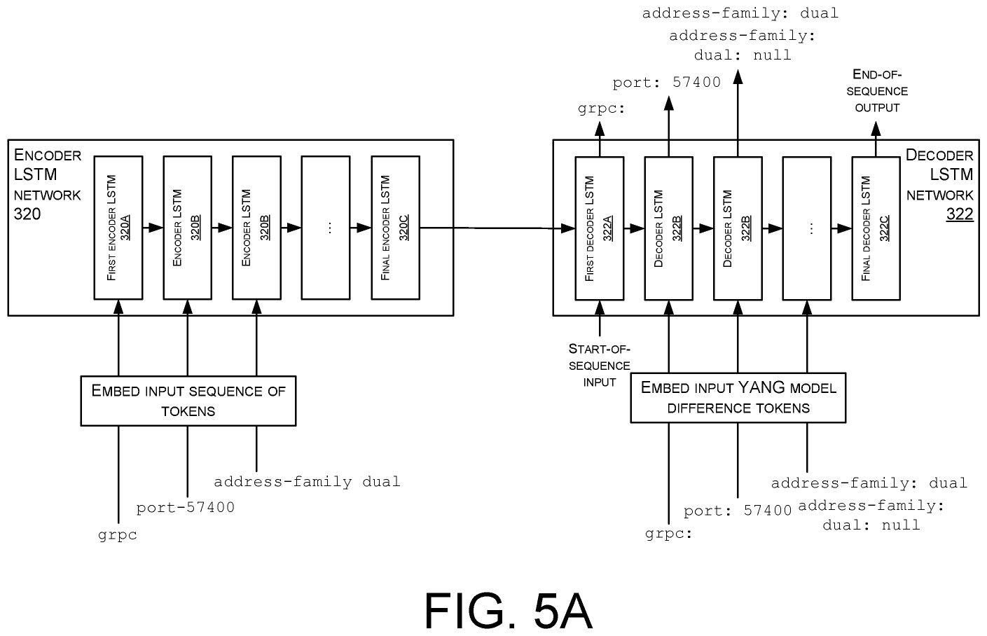

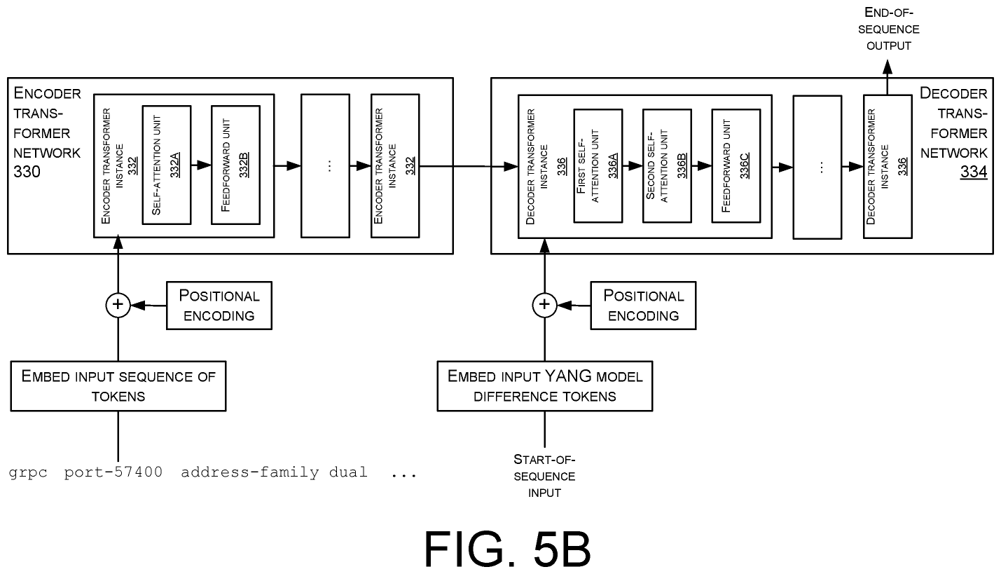

A machine learning computing system 308 is configured by a learning model 314 in memory of the machine learning computing system 308 to receive, as input, an endpoint feature vector, and output a difference feature vector. As illustrated in FIGS. 5A and 5B, a learning model 314 according to example embodiments of the present disclosure can be a sequence-to-sequence model, including an encoder 316 and a decoder 318. According to example embodiments of the present disclosure, the encoder 316 configures the machine learning computing system 308 to receive, as input, an endpoint feature vector, and output an intermediate state vector. The decoder 318 configures the machine learning computing system 308 to receive, as input, the intermediate state vector, and output a difference feature vector.

Each of the encoder 316 and the decoder 318 can be a recurrent neural network, such as a long short-term memory (“LSTM”) network as illustrated in FIG. 5A; each of the encoder 316 and the decoder 318 can alternatively be a transformer network as illustrated in FIG. 5B.

As illustrated in FIG. 5A, an encoder LSTM network 320 configures a machine learning computing system 308 to receive an input sequence of token embeddings of length T (which can be derived from an endpoint feature vector by reference to arrays described above) and output a cell memory state vector. An encoder LSTM network 320 includes some number of LSTM cells, each of which configures the machine learning computing system 308 to process one token of the input sequence of token embeddings. A first encoder LSTM cell 320A of the encoder LSTM network 320 configures the machine learning computing system 308 to receive a cell memory state vector and a first test script endpoint token as inputs, and to output an updated cell memory state vector and a hidden state vector to a subsequent encoder LSTM cell as inputs. Each subsequent encoder LSTM cell 320B except the final encoder LSTM cell configures the machine learning computing system 308 to receive a cell memory state vector, a hidden state vector, and a subsequent test script endpoint token as inputs, and output an updated cell memory state vector and an updated hidden state vector to a subsequent encoder LSTM cell as inputs. A final encoder LSTM cell 320C of the encoder LSTM network 320 configures the machine learning computing system 308 to receive a cell memory state vector, a hidden state vector, and a final test script endpoint token as inputs, and output a final hidden state vector.

In each case, the input sequence of tokens is embedded by the machine learning computing system 308 configured according to, by way of example and without limitation thereto, word2vec embeddings (pre-trained word embeddings that represent configuration tokens as fixed-length vectors based on their co-occurrence with other tokens in a large corpus of network configurations), GloVe embeddings (another type of fixed-length pre-trained word embeddings), or ELMo embeddings (contextualized word embeddings that represent configuration tokens as dynamic vectors based on their context and position in a configuration sequence), to yield an input sequence of token embeddings.

By way of example, as illustrated in FIG. 5A, a first test script token is “grpc,” identifying gRPC, the name of a communication protocol, as described above. A first subsequent test script token is “port 57400,” identifying a changeable numerical value as described above. A second subsequent test script token is “address-family-dual,” identifying a changeable string value as described above.

The final hidden state vector summarizes the input sequence of token embeddings after computations configured by each recurrent cell, and represents memory of semantic information applied to the test script endpoint tokens by semantic labeling.

A decoder LSTM network 322 configures a machine learning computing system 308 to receive a hidden state vector as input and output an output sequence of tokens of length T′. A decoder LSTM network 322 includes some number of LSTM cells, each of which configures the machine learning computing system 308 to process a YANG model difference token and generate a subsequent YANG model difference token in sequence. A first decoder LSTM cell 322A of the decoder LSTM network 322 configures the machine learning computing system 308 to receive a hidden state vector and a start-of-sequence input (i.e., a dummy input standing in for a previous token in a sequence), and to output an updated hidden state vector, and an output first YANG model difference token to a subsequent decoder LSTM cell as inputs. Each subsequent decoder LSTM cell 322B of the decoder LSTM network 322 configures the machine learning computing system 308 to receive a hidden state vector, and an input YANG model difference token, and to output an updated hidden state vector, and an output subsequent YANG model difference token to a subsequent decoder LSTM cell as inputs. A final decoder LSTM cell 322C of the decoder LSTM network 322 configures the machine learning computing system 308 to output an end-of-sequence output (i.e., a dummy output standing in for a subsequent token in a sequence).

By way of example, as illustrated in FIG. 5A, a first YANG model difference token output from the first decoder LSTM cell 322A includes “grpc:”. A first subsequent YANG model difference token output from a subsequent decoder LSTM includes “port: 57400.” A second subsequent YANG model difference token output from a subsequent decoder LSTM includes “address-family: dual” and “address-family: dual: null.” A final YANG model difference token output from the final decoder LSTM cell 322C is an end-of-sequence output. An output sequence of YANG model difference tokens includes each output YANG model difference token, in order, from the start-of-sequence output to the end-of-sequence output. Thus, starting from an initial state represented by the hidden state vector, a machine learning computing system 308 is configured to generate an output sequence of tokens, token by token.

In each case, the input YANG model difference token is embedded by the machine learning computing system 308 configured according to word2vec embeddings (pre-trained word embeddings that represent configuration tokens as fixed-length vectors based on their co-occurrence with other tokens in a large corpus of network configurations), GloVe embeddings (another type of fixed-length pre-trained word embeddings), and ELMo embeddings (contextualized word embeddings that represent configuration tokens as dynamic vectors based on their context and position in a configuration sequence).

As illustrated in FIG. 5B, an encoder transformer network 330 configures a machine learning computing system 308 to receive an input sequence of token embeddings, which can be padded to a fixed length (which can be derived from an endpoint feature vector by reference to arrays described above) and output a matrix of vectors. An encoder transformer network 330 includes some number of transformer instances, each of which configures the machine learning computing system 308 to process the entire input sequence of token embeddings. Each encoder transformer instance 332 of the encoder transformer network 330 includes a self-attention unit 332A stacked with a feedforward unit 332B.

A self-attention unit 332A configures the machine learning computing system 308 to compute self-attention values of an input sequence of token embeddings by assigning weights between tokens of the input sequence of token embeddings. The self-attention unit 332A further includes multiple attention heads, where each attention head configures the machine learning computing system 308 to compute self-attention values of the same input sequence of token embeddings based on a different head matrix. The machine learning computing system 308 is configured to concatenate the different self-attention values, and the feedforward unit 332B configures the machine learning computing system 308 to output a matrix of vectors.

The input sequence of token embeddings is embedded by the machine learning computing system 308 configured according to dynamic learned context embeddings and position embeddings, based on context and position of the configuration tokens in a configuration sequence. Context embeddings and position embeddings can be performed based on a random initialization of the embedding matrix refined during training.

A decoder transformer network 334 configures a machine learning computing system 308 to receive an input sequence of YANG model difference token embeddings and, based on a matrix of vectors, output an output sequence of tokens. A decoder transformer network 334 includes some number of transformer instances, each of which configures the machine learning computing system 308 to process the input sequence of YANG model difference token embeddings. Each decoder transformer instance 336 of the decoder transformer network 334 includes a first self-attention unit 336A stacked with a second self-attention unit 336C and a feedforward unit 336C.

Both the first self-attention unit 336A and the second self-attention unit 336B configure the machine learning computing system 308 to compute an input sequence of YANG model difference tokens based on a matrix of vectors as a head matrix of each attention head. Computation of self-attention values proceeds substantially as described above, except that output of the encoder is added to the output of each decoder transformer unit before applying layer normalization, which helps to stabilize the training process. The machine learning computing system 308 is configured to concatenate the different self-attention values, and the feedforward unit 336B configures the machine learning computing system 308 to output an output sequence of tokens.

The input sequence of YANG model difference tokens is embedded by the machine learning computing system 308 configured according to dynamic learned context embeddings and position embeddings, based on context and position of the configuration tokens in a configuration sequence. Context embeddings and position embeddings can be performed based on a random initialization of the embedding matrix refined during training.

To train the learning model 314, such as a sequence-to-sequence model, to perform the above computations, labeled and tokenized records from a training database 310 (i.e., mappings between a tokenized test script endpoint and a tokenized YANG model difference) are input into the learning model 314 during a cold-start training process as illustrated in FIG. 3. A cold-start training process refers to an iterative process wherein, during each of multiple epochs, a machine learning computing system 308 inputs the entire set of labeled and tokenized records into one executed loop of the learning model 314. The learning model 314, based on features of the training dataset, configures the machine learning computing system 308 to output a difference feature vector (which can be derived from a sequence of YANG model sequence tokens, by reference to an array as described above), and learn values of a weight set (i.e., parameters of the learning model). Values of a weight set can be randomly initialized prior to the cold-start training process.

A cost function is defined based on the computed outcome to maximize costs of erroneous outcomes which deviate from a correct outcome, correct outcomes corresponding to the mappings from endpoints to YANG model differences stored in the labeled and tokenized records. By an optimization algorithm such as gradient algorithms and the like, the cost function can be solved iteratively in each epoch based on each iteration of the training of a copy of the model, feeding the learned weight set back into the copy of the model for the next iteration of the training until the learned weights converge on a set of values (that is, a latest iteration of the learned weights is not significantly different in value from the previous iteration).

A learned weight set of a copy of a model can include learned parameters for each unit of the model. The learned parameters can correspond to interconnections between different units of the model, wherein a variable output from a computation at a first unit is weighted by a learned parameter and forwarded to a second unit as a variable for a computation at the second unit. The learned parameters are recorded as coefficients of one or more matrices, each of which represents a possible interconnection between each unit of the model. A coefficient (i.e., a learned parameter) having a nonzero value can represent an interconnection between two units of the model. A coefficient (i.e., a learned parameter) having a zero value can represent two units of the model having no interconnection therein (that is, an output from one unit is weighted to zero at an interconnection with the other unit, and thus does not factor into a computation of the other unit).

Output of a difference feature vector by the machine learning computing system 308 can be based on minimizing output of a cost function by performing gradient descent computations. A cost function can be any arbitrarily defined function based on output of the learning model, where output of the cost function represents degree of error in the output. Thus, for the machine learning computing system 308 outputting difference feature vector, the cost function can be defined to yield greater outputs, during training, for output sequences which less accurately match a test script endpoint mapped thereto.

After a cold-start training process is completed based on convergence of the learned weights, trained output of the learning model 314 can be validated against ground truth. The learned weights can be committed to a code repository integrated with build automation tools, including version control tools, which configure a development environment on any computing system to build and deploy the learning model 314 with any version of the learned weights.

By way of examples, according to a first example of the present disclosure, a test script endpoint is “ip dhcp pool POOL network IP1 IP2 default-router IP3 lease DAY HOUR MINUTE.” A corresponding endpoint feature vector is “tf. Tensor ([[2 11 8 22 21 20 18 19 7 23 15 12 13 14 1]], shape=(1, 15), dtype=int32).” Based thereon, an intermediate state vector output by the machine learning computing system configured by the encoder is:

tf.Tensor(
[[−0.49533165 −0.8083571 −0.4071517 ... 0.17434376 0.11910326
0.30731863]], shape=(1, 1024), dtype=float32)

Based thereon, a difference feature vector output by the machine learning computing system configured by the decoder is:

```
tf.Tensor(
[[ −5.005982 −8.396056 −8.007881 −6.007229 −8.704891
  2.0861294 3.884151 0.8531424 −0.13979965 −0.9676197
  1.2695725 −10.054394 0.79817796 3.6475372 1.9955423
  0.6480288 1.1568238 −1.2872497 4.90214 2.4706287
  −3.7208512 3.1746757 2.3038075 −1.5613616 2.7558057
  −2.2476957 −5.7682633 −2.680017 −10.575032 0.8424004
  3.31742 4.2690544 0.21525452 −1.3638753 −4.6106453
  14.728528 −5.7320266 1.6282179 2.0534282 4.035899
  −1.347525 −4.9011965 −6.061719 −3.7251503 1.9506463
  1.4429394 −9.152243 0.73227346 1.3131442 1.8883686
  −1.602587 2.1031265 −5.1558003 −0.8682757 1.3889482
  0.29645595 −0.31901583 3.507908 5.189716 0.7161404
  1.7807863 −4.850666 ]], shape=(1, 62), dtype=float32)
```

A corresponding YANG model difference is:

```
<ip>
  <dhcp>
    <pool xmlns=“http://cisco.com/ns/yang/cisco-ios-xe-dhcp”>
      <id> POOL </id>
      <lease>
        <lease-value>
          <days> DAY </days>
          <hours> HOUR </hours>
          <minutes> MINUTE </minutes>
        </lease-value>
      </lease>
      <default-router
        <default-router-list> IP3 </default-router-list>
      </default-router>
      <network>
        <primary-network>
          <number> IP1 </number>
          <mask> IP2 </mask>
        </primary-network>
      </network>
    </pool>
  </dhcp>
</ip>
```

By way of examples, according to a second example of the present disclosure, a test script endpoint is “aaa authentication login USER local.” A corresponding endpoint feature vector is “tf.Tensor ([2 3 4 17 24 16 1 0 0 0 0 0 0 0 0], shape=(1, 15), dtype=int32).” Based thereon, an intermediate state vector output by the machine learning computing system configured by the encoder is:

tf.Tensor(
[[−0.8399978 −0.9419297 −0.6173239 ... −0.0733844 −0.03504692
0.09780785]], shape=(1, 1024), dtype=float32)

Based thereon, a difference feature vector output by the machine learning computing system configured by the decoder is:

```
tf.Tensor(
[[ −2.9765713 2.1036918 3.1329894 3.8722086 1.871706
  −5.1921973 −0.09603372 −4.3340693 0.20197956 3.5521975
  5.4355907 −0.1246443 −7.1657195 1.5662148 0.88849336
  −7.122751 −5.404262 5.752636 3.2988174 −4.5616198
  6.289584 0.4239949 −0.08969896 0.3271492 0.6805272
  7.3392534 7.1990824 4.667258 −0.53503 −6.24389
  −0.83031875 −11.737201 −0.8676592 2.9762018 4.582312
  15.377991 4.0781193 −5.2747607 0.31085128 −0.40127712
  −9.357703 −25.592165 4.204438 5.9095945 −0.1580955
  −6.3512573 2.490558 4.549667 −1.326695 5.6371093
  −8.512527 0.693074 −2.325993 3.333916 −5.0751
  −6.8155804 −7.439122 0.8426671 3.1401646 0.5335417
  −3.4283636 5.630462 ]], shape=(1, 62), dtype=float32)
```

A corresponding YANG model difference is:

```
<aaa>
  <authentication xmlns=“http://cisco.com/ns/yang/cisco-ios-xe-aaa”>
    <login>
      <name> USER </name>
      <a1> <local/> </a1>
    </login>
  </authentication>
</aaa>
```

In addition to the cold-start training process as described above, the machine learning computing system 308 is further configured to perform a warm-start training process based on learned weights previously trained on a learning model 314. The machine learning computing system 308 is configured to perform a warm-start training process similarly to a cold-start training process as described above, except that the weight set is initialized as the learned weights previously trained, rather than randomly. Subsequent versions of the learned weights can be committed to a code repository under version control, such that any version of the learned weights can be deployed, not just the latest.

The machine learning computing system 308 can be configured to perform a warm-start training process whenever the training database 310 grows by a particular size, grows by a particular number of records, and the like, as a result of telemetry capture in network environments to generate training datasets as described above.

In a warm-start training process, learned weights can converge more quickly than in a cold-start training process, thereby reducing computational cost of training while further improving trained performance of the machine learning computing system 308.

Subsequently, during a production workflow as illustrated in FIG. 4, a machine learning computing system 308 reads learned weights committed to a code repository under version control, and loads a version of the learned weights into a learning model 314 included in a protocol-independent endpoint translation service 324 running on the machine learning computing system 308. Again, the network device 304 transmits test script endpoints over any data communication interface of the network device 304 (such as an input/output interface or a network interface) across a data bus, a wired or wireless network connection, and the like, to any data communication interface of the machine learning computing system 308. During a production workflow, the network device 304 does not transmit any YANG model differences or mappings.

A preprocessing library 312 configures the machine learning computing system 308 to receive test script endpoints as input, and output feature vectors which encode features of those test script endpoints. As described above, the machine learning computing system 308 is configured to perform preprocessing tasks upon test script endpoints, which can include, without limitation thereto, tokenization, semantic labeling, and vectorization.

A learning model 314, based on the learned weights, configures the machine learning computing system 308 to receive, as input, an endpoint feature vector, and output a difference feature vector. As described above, a learning model 314 according to example embodiments of the present disclosure can be a sequence-to-sequence model, including an encoder and a decoder.

It should be understood that the learning model 314 can output a feature vector corresponding to a tokenized YANG model difference. A YANG parser service 326 can configure the machine learning computing system 308 to translate the feature vector to a corresponding tokenized YANG model difference by reference to a second array as described above.

The machine learning computing system 308 is configured to return the YANG model difference to the network device 304, whereupon the network device 304 can apply a YANG model difference in changing configuration of the network device 304.

FIG. 6A illustrates an example system architecture of a machine learning computing system 600 configured to compute machine learning tasks according to example embodiments of the present disclosure.

According to example embodiments of the present disclosure, a machine learning computing system 600 may include any number of general-purpose processors 602 and any number of special-purpose processors 604. The general-purpose processors 602 and special-purpose processors 604 may be physical processors and/or may be virtual processors, and may include any number of physical and/or virtual cores and be distributed amongst any number of physical and/or virtual nodes and any number of physical and/or virtual clusters. The general-purpose processors 602 and special-purpose processors 604 may each be configured to execute one or more instructions stored on a computer-readable storage medium, such as models as described above, to cause the general-purpose processors 602 or special-purpose processors 604 to compute tasks such as machine learning tasks. Special-purpose processors 604 may be computing devices having hardware or software facilitating computation of machine learning tasks such as training and inference computations. For example, special-purpose processors 604 may be accelerators, such as GPUs as described above, and/or the like. To facilitate computation of tasks such as training and inference, special-purpose processors 604 may, for example, implement engines operative to compute mathematical operations such as matrix arithmetic.

The general-purpose processors 602 and special-purpose processors 604 may perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

A machine learning computing system 600 may further include a system memory communicatively coupled to the general-purpose processors 602 and the special-purpose processors 604 by a data bus 608 as described above. The system memory 606 may be physical or may be virtual, and may be distributed amongst any number of nodes and/or clusters. The system memory 606 may be volatile, such as RAM, non-volatile, such as ROM, flash memory, miniature hard drive, memory card, and the like, or some combination thereof.

The data bus 608 provides an interface between the general-purpose processors 602, the special-purpose processors 604, and the remainder of the components and devices of the machine learning computing system 600. The data bus 608 may provide an interface to a RAM, used as the main memory in the machine learning computing system 600. The data bus 608 may further provide an interface to a computer-readable storage medium such as a read-only memory (“ROM”) or non-volatile RAM (“NVRAM”) for storing basic routines that help to startup the machine learning computing system 600 and to transfer information between the various components and devices. The ROM or NVRAM may also store other software components necessary for the operation of the machine learning computing system 600 in accordance with the configurations described herein.

The machine learning computing system 600 may operate in a networked environment using logical connections to remote computing devices and computer systems through a network. The data bus 608 may include functionality for providing network connectivity through a NIC 612, such as a gigabit Ethernet adapter. The NIC 612 is capable of connecting the machine learning computing system 600 to other computing devices over a network. It should be appreciated that multiple NICs 612 may be present in the machine learning computing system 600, connecting the machine learning computing system 600 to other types of networks and remote computer systems.

The machine learning computing system 600 may be connected to a storage device 614 that provides non-volatile storage for the machine learning computing system 600. The storage device 614 may store an operating system 616, programs 618, a BIOS, and data, which have been described in greater detail herein. The storage device 614 may be connected to the machine learning computing system 600 through a storage controller 620 connected to the data bus 608. The storage device 614 may consist of one or more physical storage units. The storage controller 620 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The machine learning computing system 500 may store data on the storage device 614 by transforming the physical state of the physical storage units to reflect the information being stored. The specific transformation of physical state may depend on various factors, in different embodiments of this description. Examples of such factors may include, but are not limited to, the technology used to implement the physical storage units, whether the storage device 614 is characterized as primary or secondary storage, and the like.

For example, the machine learning computing system 600 may store information to the storage device 614 by issuing instructions through the storage controller 620 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The machine learning computing system 600 may further read information from the storage device 614 by detecting the physical states or characteristics of one or more particular locations within the physical storage units.

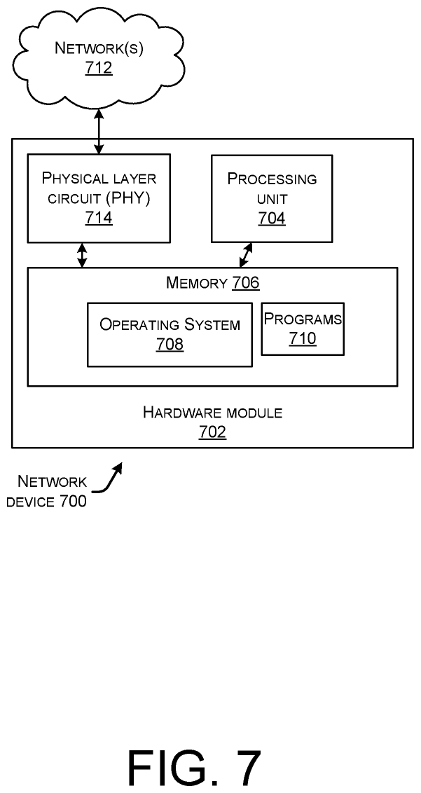

In addition to the storage device 614 described above, the machine learning computing system 600 may have access to other computer-readable storage media to store and retrieve information, such as program modules, data structures, or other data. It should be appreciated by those skilled in the art that computer-readable storage media is any available media that provides for the non-transitory storage of data and that may be accessed by the machine learning computing system 600. In some examples, the operations performed by a router node of the network overlay, and or any components included therein, may be supported by one or more devices similar to the machine learning computing system 600. Stated otherwise, some or all of the operations performed for computing machine learning tasks may be performed by one or more machine learning computing system 600 operating in a networked, distributed arrangement over one or more logical fabric planes over one or more networks, as described in further detail subsequently with reference to FIG. 7.

By way of example, and not limitation, computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that may be used to store the desired information in a non-transitory fashion.

As mentioned briefly above, the storage device 614 may store an operating system 616 utilized to control the operation of the machine learning computing system 600. According to one embodiment, the operating system comprises the LINUX operating system and derivatives thereof. According to another embodiment, the operating system comprises the WINDOWS operating system from MICROSOFT CORPORATION of Redmond, Washington. It should be appreciated that other operating systems may also be utilized. The storage device 614 may store other system or application programs and data utilized by the machine learning computing system 600.

In one embodiment, the storage device 614 or other computer-readable storage media is encoded with computer-executable instructions which, when loaded into memory of a computer, transform the computer from a general-purpose computing system into a special-purpose computer capable of implementing the embodiments described herein. These computer-executable instructions transform the machine learning computing system 600 by specifying how the general-purpose processors 602 and special-purpose processors 604 transition between states, as described above. According to one embodiment, the machine learning computing system 600 has access to computer-readable storage media storing computer-executable instructions which, when executed by the machine learning computing system 600, perform the various processes described above with regard to FIGS. 1-5. The machine learning computing system 600 may also include computer-readable storage media having instructions stored thereupon for performing any of the other computer-implemented operations described herein.

FIG. 6B illustrates an example of special-purpose processors 604 according to example embodiments of the present disclosure. The special-purpose processors 604 may include any number of cores 622. Processing power of the special-purpose processors 604 may be distributed among the cores 622. Each core 622 may include local memory 624, which may contain initialized data, such as parameters and hyperparameters, for the performance of computing machine learning tasks. Each core 622 may further be configured to execute one or more sets of model units 626 initialized on local storage 628 of the core 622, which may each be executable by the cores 622, including concurrent execution by multiple cores 622, to perform, for example, arithmetic operations such as matrix arithmetic and the like for the purpose of machine learning tasks.

Example embodiments of the present disclosure may be implemented on server hosts and remote computing hosts. Server hosts may be any suitable networked server, such as cloud computing systems, which may provide collections of servers hosting computing resources such as an information retrieval frontend, a database, and a DBMS. Remote computing hosts such as data centers may host learning models to provide functions according to example embodiments of the present disclosure to convert unstructured search queries to structured database queries for the benefit of the hosted computing resources.

FIG. 7 shows an example architecture for a network device 700 capable of being configured to implement the functionality described above. The architecture shown in FIG. 7 illustrates a computing device assembled from modular components, and can be utilized to execute any of the software components presented herein.

The network device 700 can include one or more hardware modules 702, which can be a physical card or module to which a multitude of components or devices can be connected by way of a system bus or other electrical communication paths. Such a physical card or module can be housed in a standalone network device chassis, or can be installed in a rack-style chassis alongside any number of other physical cards or modules. In one illustrative configuration, one or more processing units 704 can be standard programmable processors or programmable ASICs that perform arithmetic and logical operations necessary for the operation of the hardware module 702.

The processing units 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

Integrated circuits can provide interfaces between the processing units 704 and the remainder of the components and devices on the hardware module 702. The integrated circuits can provide an interface to memory 706 of the hardware module 702, which can be implemented as on-chip memory such as TCAM, for storing basic routines configuring startup of the hardware module 702 as well as storing other software components necessary for the operation of the hardware module 702 in accordance with the configurations described herein. The software components can include an operating system 708, programs 710, and data, which have been described in greater detail herein.

The hardware module 702 can establish network connectivity in a network 712 by forwarding packets over logical connections between remote computing devices and computer systems. The integrated circuits can provide an interface to a physical layer circuit (PHY) 714 of the hardware module 702, which can provide Ethernet ports which enable the hardware module 702 to function as an Ethernet network adapter.

The hardware module 702 can store data on the memory 706 by transforming the physical state of the physical memory to reflect the information being stored. The specific transformation of physical state can depend on various factors, in different embodiments of this description. Examples of such factors can include, but are not limited to, the technology used to implement the memory 706, whether the memory 706 is characterized as primary or secondary storage, and the like.

For example, the hardware module 702 can store information to the memory 706 by issuing instructions through integrated circuits to alter the electrical characteristics of a particular capacitor, transistor, or other discrete component in a solid-state storage unit. Other transformations of physical media are possible without departing from the scope and spirit of the present description, with the foregoing examples provided only to facilitate this description. The hardware module 702 can further read information from the memory 706 by detecting the physical states or characteristics of one or more particular locations within the memory 706.

The memory 706 described above can constitute computer-readable storage media, which can be any available media that provides for the non-transitory storage of data and that can be accessed by the hardware module 702. In some examples, the operations performed by the network device 700, and/or any components included therein, can be supported by one or more devices similar to the hardware module 702. Stated otherwise, some or all of the operations performed by the network device 700, and/or any components included therein, can be performed by one or more hardware modules 702 operating in a networked, distributed or aggregated arrangement over one or more logical fabric planes over one or more networks.

By way of example, and not limitation, computer-readable storage media can include volatile and non-volatile, removable and non-removable media implemented in any method or technology. Computer-readable storage media includes, but is not limited to, TCAM, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the memory 706 can store an operating system 708 utilized to control the operation of the hardware module 702. According to one embodiment, the operating system comprises the CISCO IOS operating system from CISCO SYSTEMS INC. of San Jose, California. It should be appreciated that other operating systems can also be utilized. The memory 706 can store other system or application programs and data utilized by the hardware module 702.

In one embodiment, the memory 706 or other computer-readable storage media is encoded with computer-executable instructions which transform any processing units 704 from a general-purpose computing system into a special-purpose computer capable of implementing the embodiments described herein. These computer-executable instructions specify how the processing units 704 transition between states, as described above. According to one embodiment, the hardware module 702 has access to computer-readable storage media storing computer-executable instructions which, when executed by the hardware module 702, perform the various processes described above with regard to FIGS. 1-5. The hardware module 702 can also include computer-readable storage media having instructions stored thereupon for performing any of the other computer-implemented operations described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A network device comprising:
one or more processing units; and
one or more non-transitory computer-readable media storing computer-executable instructions that, when executed by the one or more processing units, cause the one or more processing units to:
capture a pre-execution YANG model before executing a test script;
capture a post-execution YANG model after executing the test script;
compute a YANG model difference corresponding to the test script by comparing the pre-execution YANG model and the post-execution YANG model; and
record the YANG model difference in a training dataset stored on a machine learning computing system.

2. The network device of claim 1, wherein the computer-executable instructions further cause the one or more processing units to map a test script endpoint of the test script to the YANG model difference.

3. The network device of claim 2, wherein the computer-executable instructions further cause the one or more processing units to record the test script endpoint and a mapping between the test script endpoint and the YANG model difference in the training dataset.

4. The network device of claim 1, wherein the computer-executable instructions further cause the one or more processing units to parse a configuration output of a network management protocol; and the pre-execution YANG model and the post-execution YANG model each comprises a configuration of the network device.

5. The network device of claim 1, wherein the computer-executable instructions further cause the one or more processing units to parse a state output of a network management protocol; and the pre-execution YANG model and the post-execution YANG model each comprises a state of the network device.

6. A machine learning computing system comprising:
one or more processing units; and
one or more non-transitory computer-readable media storing computer-executable instructions that, when executed by the one or more processing units, cause the one or more processing units to:
input a training dataset into a learning model during a training process wherein a set of learned weights converge;
receive, as input, an endpoint feature vector corresponding to a tokenized test script endpoint; and
output, based on the set of learned weights, a difference feature vector corresponding to a tokenized YANG model difference;
wherein the training dataset comprises a YANG model difference corresponding to a test script.

7. The machine learning computing system of claim 6, wherein the computer-executable instructions further cause the one or more processing units to perform tokenization, perform semantic labeling, and perform vectorization upon the training dataset.

8. The machine learning computing system of claim 7, wherein the training dataset further comprises a test script endpoint and a mapping between the test script endpoint and the YANG model difference.

9. The machine learning computing system of claim 8, wherein tokenization is performed upon a test script endpoint to output a test script endpoint token, and is performed upon a YANG model difference to output a YANG model difference token.

10. The machine learning computing system of claim 9, wherein semantic labeling causes at least one test script endpoint token to be labeled as a changeable numerical value or as a changeable string value, and causes at least one YANG model difference token to be labeled as a changeable numerical value or as a changeable string value.

11. The machine learning computing system of claim 9, wherein the computer-executable instructions further cause the one or more processing units to insert a test script endpoint token into a first array, and insert a YANG model difference token into a second array.

12. The machine learning computing system of claim 6, wherein the learning model comprises a sequence-to-sequence model, the sequence-to-sequence model comprising an encoder and a decoder.

13. The machine learning computing system of claim 12, wherein the encoder and the decoder respectively comprise recurrent neural networks.

14. The machine learning computing system of claim 13, wherein the encoder comprises an encoder long short-term memory (“LSTM”) network and the decoder comprises a decoder LSTM network.

15. The machine learning computing system of claim 12, wherein the encoder comprises an encoder transformer network and the decoder comprises a decoder transformer network.

16. A method comprising:
capturing, by a network device, a YANG model of at least one of a configuration of the network device according to a network management protocol and state of the network device according to the network management protocol;
recording, on storage of a machine learning computing system, a YANG model difference in a training dataset, wherein the YANG model difference compares a pre-execution YANG model captured before executing a test script and a post-execution YANG model captured after executing the test script; and
inputting, by the machine learning computing system, the training dataset into a learning model during a training process wherein a set of learned weights converge.

17. The method of claim 16, further comprising recording, by the network device, a test script endpoint and a mapping between the test script endpoint and the YANG model difference in the training dataset.

18. The method of claim 17, further comprising performing, by the machine learning computing system, tokenization, semantic labeling, and vectorization upon the training dataset.

19. The method of claim 16, further comprising receiving, by the machine learning computing system as input, an endpoint feature vector corresponding to a tokenized test script endpoint, and outputting, by the machine learning computing system based on the set of learned weights, a difference feature vector corresponding to a tokenized YANG model difference.

20. The method of claim 16, further comprising inputting, by the machine learning computing system, the training dataset into the learning model during a warm-start training process based on the set of learned weights.
